(19) United States
(12) Patent Application Publication
(10) Pub. No.: US 2014/0173018 A1
(43) Pub. Date: Jun. 19, 2014

(54) Content Based Traffic Engineering in Software Defined Information Centric Networks

(71) Applicant: Futurewei Technologies, Inc., Plano, TX (US)

(72) Inventors: Cedric Westphal, San Francisco, CA (US); Abhishek Chanda, New Brunswick, NJ (US)

(73) Assignee: Futurewei Technologies, Inc., Plano, TX (US)

(21) Appl. No.: 14/106,515

(22) Filed: Dec. 13, 2013

Related U.S. Application Data
(60) Provisional application No. 61/736,833, filed on Dec. 13, 2012.
(60) Provisional application No. 61/739,582, filed on Dec. 19, 2012.

(51) Int. Cl. H04L 12/911; H04L 29/08

(52) U.S. Cl. CPC H04L 47/70; H04L 67/2842
USPC 709/213; 709/217

(57) ABSTRACT

A method implemented by a network controller, the method comprising obtaining metadata of a content, wherein the content is requested by a client device, allocating one or more network resources to the content based on the metadata of the content, and sending a message identifying the allocated network resources to a switch to direct the content to be served to the client device, wherein the switch is controlled by the network controller and configured to forward the content to the client device using the allocated network resources.

### CROSS-REFERENCE TO RELATED APPLICATIONS

The present application claims priority to U.S. Provisional Patent Application No. 61/736,833 filed Dec. 13, 2012 by Cedric Westphal et al. and entitled “An End-Point Agnostic Method to Transparently Manage Content Distribution in an OpenFlow Network”, and U.S. Provisional Patent Application No. 61/739,582 filed Dec. 19, 2012 by Cedric Westphal et al. and entitled “A Method to Extract Metadata and Context for Traffic Engineering and Firewalling Applications in a Software Defined Information Centric Network”, both of which are incorporated herein by reference as if reproduced in their entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Caching provides a generic mechanism for temporary storage of a content or object, often in response to frequent requests or demands for contents stored in a caching device. If a cache is placed in or close to a region from where a client device sends a request, the resulting access latency may be lower for contents. Traditional caching solutions may require some form of modification to end hosts including clients and servers. For example, in a traditional caching solution, a proxy server may be used to point to a cache, and the networking configuration of a client device may be changed to point to that proxy server for a specific type of traffic. The traditional caching solution may not scale well for a generic network where a number of clients may be on the order of thousands or even millions, such as in content distribution systems and companies (e.g., NETFLIX, AKAMAI, and FACEBOOK) that use such systems. Further, the traditional caching solution may be prone to errors and may prove difficult to maintain in some large scale systems. For example, if a proxy changes its Internet Protocol (IP) address, clients (which may be on the order of millions for some networks) using the proxy may need to be reconfigured. Client reconfiguration on such order may be complex to implement.

Some caching solutions attempted by researchers try to modify networking configuration at end-points to point to a proxy, which may then be used to perform content identification and subsequent mapping of content to flows. In such solutions, reconfiguration of clients (although not servers) to use the proxy may be needed while connecting. However, practical limitations may render this solution cumbersome and error-prone, since modification of client configurations over a large number of client devices (or run a script) may be required.

Further, other caching solutions attempted by researchers try to modify a networking stack in a client and a server to support dynamic content identification and mapping of content to flows. In this case, server software may be modified to implement a feedback mechanism, which may raise a flag when a content is being pushed in the network. This approach may eliminate the need for dynamic content identification, and content may be mapped to Transmission Control Protocol (TCP) flows intrinsically. However, practical limitations may include potential difficulty in proposing a modification to every server.

### SUMMARY

In one embodiment, the disclosure includes a method implemented by a network controller, the method comprising obtaining metadata of a content, wherein the content is requested by a client device, allocating one or more network resources to the content based on the metadata of the content, and sending a message identifying the allocated network resources to a switch to direct the content to be served to the client device, wherein the switch is controlled by the network controller and configured to forward the content to the client device using the allocated network resources.

In another embodiment, the disclosure includes an apparatus comprising a receiver configured to receive metadata of a content from a switch located in a same network with the apparatus, wherein the content is requested by a client device, a processor coupled to the receiver and configured to allocate one or more network resources to the content based on the metadata of the content, and direct the content to be served to the client device using the allocated network resources, and a transmitter coupled to the processor and configured to transmit a message identifying the allocated network resources to the switch.

In yet another embodiment, the disclosure includes a method implemented by a switch located in a network compliant to a software defined networking (SDN) standard, the method comprising receiving a request for a content, wherein the request is originated from a client device, extracting metadata of the content, forwarding the metadata to a controller configured to manage the network, and receiving instructions from the controller identifying one or more network resources allocated to serving the content to the client device, wherein the one or more network resources are allocated by the controller based at least in part on the metadata.

In yet another embodiment, the disclosure includes a switch located in a network, the switch comprising at least one receiver configured to receive a request for a content, wherein the request is originated from a client device, a processor coupled to the at least one receiver and configured to extract metadata of the content, and one or more transmitters coupled to the processor and configured to forward the metadata to a controller managing the network, wherein the at least one receiver is further configured to receive instructions from the controller identifying one or more network resources allocated to serving the content to the client device, and wherein the one or more network resources are allocated by the controller based at least in part on the metadata.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram showing an end-to-end view of an embodiment of a network model.

FIG. 2 is a schematic diagram showing an embodiment a network architecture highlighting some network components.

FIG. 3 is a diagram of an embodiment of a software defined networking (SDN) implementation.

FIG. 4 is a diagram showing an embodiment of a message exchange protocol.

FIG. 5 is a diagram of another embodiment of a message exchange protocol.

FIG. 6 is a diagram showing simulation results.

FIG. 7 is another diagram showing simulation results.

FIG. 8 is a flowchart of an embodiment of a method, which may be implemented by a network controller.

FIG. 9 is a flowchart of an embodiment of a method, which may be implemented by an SDN switch.

FIG. 10 is a diagram of an embodiment of a network unit.

FIG. 11 is a diagram of an embodiment of a computer system.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

OpenFlow may be used as an enabling technology for content caching. OpenFlow is an open-source software defined networking (SDN) standard or protocol that may enable researchers to run experimental protocols in campus networks. In a classical router or switch, fast packet forwarding (data path) and high level routing decisions (control path) may be implemented on the same device. An OpenFlow approach may separate the data path and control path functions. For example, a data path or data plane may still reside on a switch, but high-level routing decisions may be moved to a centralized network controller, which may be implemented using a network server that oversees a network domain. An OpenFlow switch and an OpenFlow controller may communicate via the OpenFlow protocol, which defines messages such as those denoted as packet-received, send-packet-out, modify-forwarding-table, and get-stats.

The data plane of an OpenFlow switch may present a clean flow table abstraction. Each entry in a flow table may contain a set of packet fields to match, and an action (e.g., send-out-port, modify-field, or drop) associated with the packet fields. In use, when the OpenFlow switch receives a packet it has never seen before and for which it has no matching flow entries, the OpenFlow switch may send the packet to an OpenFlow controller overseeing the switch. The controller may then make a decision regarding how to handle the packet. For example, the controller may drop the packet, or add a flow entry to the switch that instructs the switch on how to forward similar packets in the future. In practice, OpenFlow networks may be relatively easier to manage and configure than other types of networks due to the presence of a centralized controller that may be capable of configuring all devices in a network. In addition, the controller may inspect a network traffic traveling through the network and make routing decisions based on the nature of the network traffic.

Further, Information Centric Network (ICN) architectures may be implemented based on SDN to alleviate the problems associated with traditional networks by operating on content at different levels or layers. An ICN may use content names to provide network services such as content routing and content delivery. To facilitate content service, an ICN architecture may set up a content management layer to handle routing based on content names. In the ICN, some network nodes may be assumed to have different levels of temporary storage. An ICN node may provide caching to store contents indexed by content names.

The present disclosure may overcome aforementioned problems or limitations by teaching an end-point (e.g., server, client, etc.) agnostic approach for content management in a network environment. Disclosed embodiments may identify one or more data flows or traffic flows in the network and map the traffic flows to one or more contents (e.g., audio, text, image, video, etc.). On the other hand, disclosed embodiments may identify a content, map the identified content to one or more data flows, and route the data flows. Further, the end-point (server and client) agnostic approach may be used to extract content metadata on a network layer of a content or information centric network (ICN), which may be based on SDN. The content metadata may describe attributes of a piece of content, such as file name, content size, Multipurpose Internet Mail Extensions (MIME) type, etc. Extracting content metadata may be achieved “for free” as a by-product of the ICN paradigm. After being extracted, the content metadata may be used to perform various metadata driven services or functions such as efficient firewalling, traffic engineering (TE), other allocation of network resources, and network-wide cache management based on a function of size and popularity. Various goals or objectives, such as bandwidth optimization, disk write optimization on cache, etc., may be used in designing these functions, and the optimization goals may vary depending on the application. For example, embodiments disclosed herein may reduce access latency of web content and/or bandwidth usage without any modification to a server or to a client.

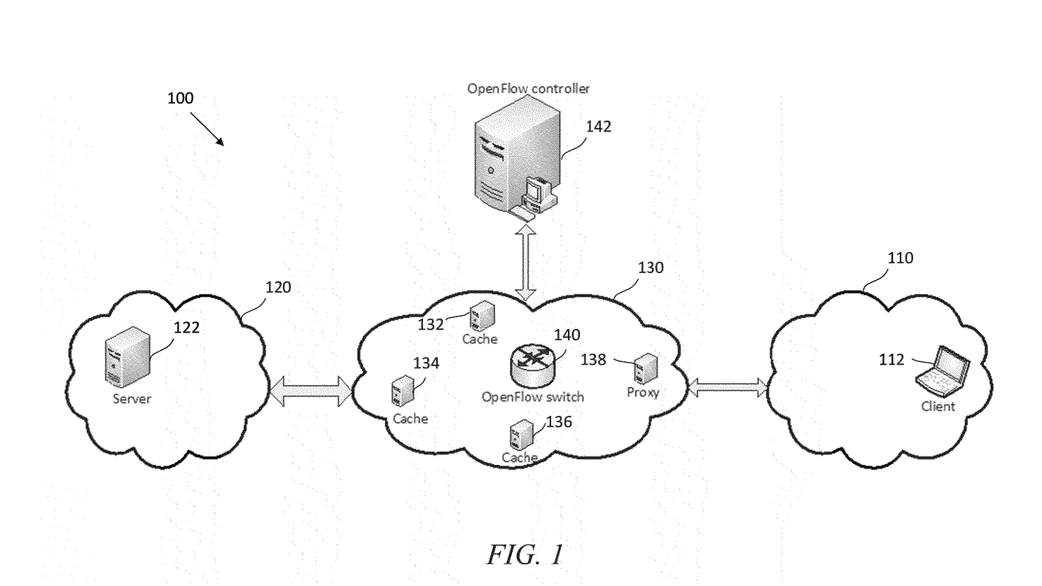

FIG. 1 is a schematic diagram showing an end-to-end view of an embodiment of a network model 100, which may comprise one or more networks or network domains. For example, the network model 100 as portrayed in FIG. 1 comprises a client network 110, a service provider network 120, and an intermediate network 130 therebetween. One or more end users or clients (e.g., a client 112) may be located in the client network 110, and one or more servers (e.g., a server 122) may be located in the service provider network 120. The network 130 connects the client network 110 and the service provider network 120. Note that although portrayed as different networks, depending on the implementation, the client 112, the server 122, and their intermediate network nodes may also be located in the same network.

The network 130 may be implemented as an SDN network (e.g., using OpenFlow as communication protocol). In this case, the major components of the network 130 may comprise one or more caching elements (e.g., caches 132, 134, and 136), one or more proxy elements (e.g., a proxy 138), one or more switches (e.g., an OpenFlow switch 140), and at least one controller (e.g., an OpenFlow controller 142). The controller 142 may be configured to run a module which controls all other network elements. The proxy 138 and the caches 132-136 may communicate with the controller 142, thus the proxy 138 and the caches 132-136 may be considered as non-forwarding OpenFlow elements.

The SDN network 130 may be controlled by the controller 142 (without loss of generality, only one controller 142 is illustrated for the network 130). The controller 142 may run a content management layer (within a control plane) that manages content names (e.g., in the form of file names), translates them to routable addresses, and manages caching policies and traffic engineering. For example, the control plane may translate information on the content layer to flow rules, which may then be pushed down to switches including the switch 140. Some or all switches in the network 130 may have ability to parse content metadata from packets and pass the content metadata on to the content management layer in the controller 142.

This disclosure may take the view point of a network operator. Assume that a content is requested by the client 112 from the server 122, both of which can be outside of the network 130. In an embodiment, the network 130 may operate with a control plane which manages content. Namely, when a content request from the client 112 arrives in the network 130, the control plane may locate a proper copy of the content (internally in a cache (e.g., cache 132), or externally from its origin server 122). Further, when content objects from the server 122 arrive in the network 130, the control plane may have the ability to route the content and fork the content flow towards a cache (on the path or off the path). Further, the control plane may leverage ICN semantics, such as content-centric networking (CCN) interest and data packets, to identify content. Alternatively, the control plane may be built upon existing networks, e.g., using SDN concepts. This disclosure may work in either context, but is described herein mostly as built upon SDN, so that legacy clients and legacy servers may be integrated with the caching network 130.

The service provider network 120 may connect to the network 130 using one or more designated ingress switches. The disclosed implementation may not require any modification to the client network 110 or the service provider network 120. The network 130 may be implemented as a content distribution system that can be plugged into an existing networking infrastructure. For instance, the network 130 may be plugged in between and connect to each of them over some tunneling protocol. The network 130 may decrease the latency of content access while making network management relatively easy and seamless.

When the client 112 wishes to connect to the server 122 (e.g., a content server from which contents are served or originated) by sending a packet comprising a request for content, an ingress OpenFlow switch (e.g., the switch 140) may forward the packet to the controller 142. The controller 142 may write flows to divert Transmission Control Protocol (TCP) connections from the client 112 to the proxy 138. The proxy 138 may parse the client's request to check if the content is cached somewhere in the network 130. If the content is not cached in the network 130, the proxy 138 may inform the controller 142, which may then select a cache to store the content, e.g., by writing flows to divert a copy of the content from the server 122 to the cache. In each step, the controller 142 may maintain a global state of all caches in the network 130, e.g., which cache stores a specified content.

In use, when a piece of previously cached and indexed content is requested, the content may be served back from the cache (e.g., the cache 132) instead of the server 122. The proxy 138 (or another proxy not shown in FIG. 1), which may be transparent to the client 112, may be used to multiplex between the server 122 and the cache 132. When the controller 142 sees that the client 112 is requesting content from the server 122, the controller 142 may redirect the flow to the proxy 138 and assign a port number. Thus, the controller 142 may know the mapping between port numbers on the proxy 138, between the source port and the source IP address, and between the destination port and the destination IP address. When the server 122 in a cache miss case (or the cache 132 in a cache hit case) sends back a data flow carrying the content, the data flow may be mapped back to the original server 122 using the information stored in the controller 142.

The network 130 may allow content identification and mapping independent of any software running on end devices including both the server 122 and the client 112, which may remain agnostic to the location of a content. Further, no modification may be needed to the end devices or their local networks 110 and 120. If the server 120 and the client 112 are located in two different networks, as shown in FIG. 1, the network 130 may be plugged in between the server 120 and the client 112 as an intermediate network that can identify content seamlessly. Also, the process of content management and routing may remain transparent from the perspective of the end devices, that is, the end devices may not notice any changes in the way content is requested or served. Thus, this disclosure differs from existing mechanisms that require some form of modification to either the configurations of end devices or their local networks.

This disclosure may map an identified content to one or more data flows or traffic flows in the network 130. The identified content may be mapped back to data flows in the network 130 using fields that a switch would recognize in a packet header, such as port numbers, private IP addresses, virtual local area network (VLAN) tags, or any combinations of fields in the packet header. The OpenFlow controller 142 may maintain a database that maps port numbers on the proxy 138 with server and client credentials. Thus, at the client's end, a data flow may originate from the proxy 138 instead of the server 122, as OpenFlow may allow rewriting a source address and a port number, in a data flow going through the proxy 138, to a source address and a port number of the server 120.

The caches 132-136 may be placed in the network 130 which is controlled by the controller 142. Once a content has been identified, the controller 142 may decide to cache the content. Specifically, the controller 142 may select a cache (assume the cache 132), write appropriate flows to re-direct a copy of the content towards the cache 132, record location of the cache 132 as the location of the content. In content service, when the controller 142 sees a new request for the same content, the controller 142 may redirect the new request to the cache 132 where the controller 142 stored the content. Obtaining the content from the cache 132 instead of the server 122 may result in decreased access latency, since the cache 132 may be geographically closer to the client 112 than the server 122. Further, since there is no need to get the content from the server 122 each time, network bandwidth between the cache 132 and the server 122 may be saved, improving overall network efficiency.

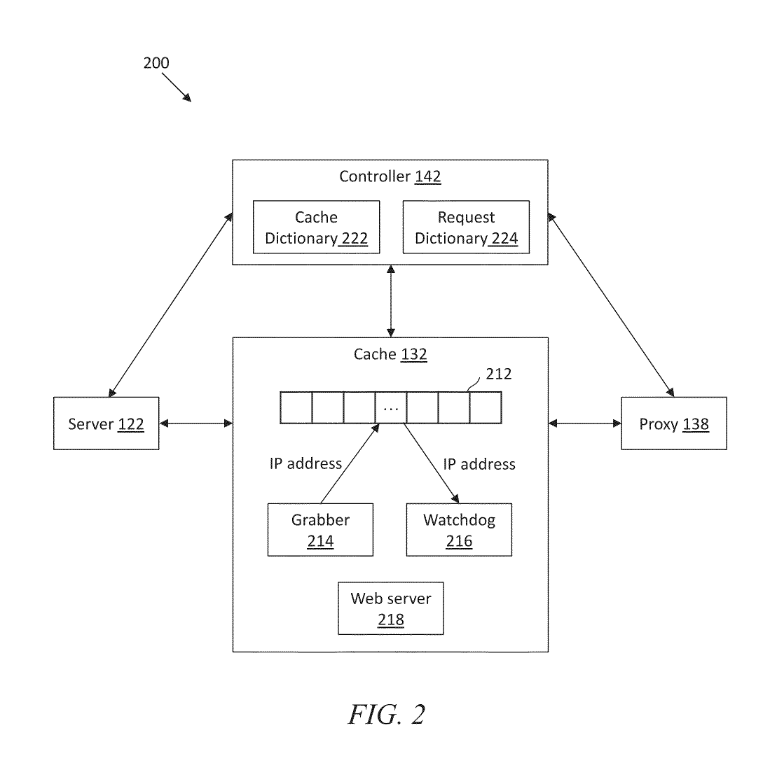

FIG. 2 is a schematic diagram showing an embodiment of a network architecture 200, which highlights detailed components in some of the network devices shown in FIG. 1. The architecture 200 may be a scalable architecture for using explicitly finite nature of content semantic. Each of the network devices in the architecture 200 may be implemented, however suitable, e.g., using hardware or a combination of hardware and software. For example, the proxy 138 may be written in pure Python and may use a library dubbed as the tproxy library. The tproxy library may provide methods to work with Hypertext Transfer Protocol (HTTP) headers, as there may not be another way to access any TCP or IP information in the proxy 138. The proxy 138 may use an Application Programming Interface (API), such as the Representational State Transfer (REST) API, to communicate with the controller 142. For example, communications between the proxy 138 and the controller 142 may be instantiated with the following command to call a proxy function defined as tproxy:

sudo tproxy <script.py> −b 0.0.0.0:<port number>

According to the disclosed implementation, the proxy 138 may run multiple instances of the proxy function on different ports. Each of those instances may proxy one <client, server> pair. An embodiment of a proxy algorithm is shown in Table 1. As one of ordinary skill in the art will recognize the functioning of the pseudo code in Table 1 and other tables disclosed herein, the tables are not described in detail herein in the interest of conciseness.

TABLE 1
An examplary algorithm implemented by the proxy 138

Send HELLO to controller;
Send a list of proxy ports to the controller;
Listen on all proxy ports;
if a GET request arrives then

| \| | Parse the file uri from the request; | |
|---|---|---|
| \| | Query controller with the file uri; | |
| \| | if the controller returns an IP address and port then | |
| \| | \| | Redirect all requests to that IP address and port; |
| \| | else | |
| \| | \| | Update controller with (fulluri, filename, destIP, destport); |
| \| | \| | Pass the request unmodified; |

| | |
|---|---|
| \| | end |

else

| | |
|---|---|
| \| | Do not proxy; |

end

In some embodiments, the disclosed caches (e.g., the caches 132-136) may be different from existing Internet caches in a number of ways. For example, a disclosed cache may interface with an OpenFlow controller (e.g., the controller 142). Consequently, the disclosed cache may not implement conventional caching protocols simply because there cache may not need to do so. A standard Internet cache may see a request and, if there is a cache miss, may forward the request to a destination server. When the destination server sends back a response, the standard Internet cache may save a copy of the content and index the copy by the request metadata. Thus, a TCP connection may be setup between the standard Internet cache and the server, and the TCP connection may use a socket interface. In comparison, certain embodiments of a disclosed cache may see only a response to a request and not the request itself. Since in these embodiments the disclosed cache may get to hear just one side of the connection, it may not have a TCP session with the server and, consequently, may not operate with a socket level abstraction. Thus, in these embodiments the disclosed cache may listen to and read packets from a network interface.

In an embodiment, a disclosed cache (e.g., the cache 132, 134, or 136) may comprise a plurality of components or modules including a queue which may be implemented using a Redis server, a module that watches the cache directory for file writes, a web server that serves back the content, and a module that snoops on a network interface and assembles packets. As shown in FIG. 2, the cache 132 comprises a Redis queue 212, a grabber module 214, a watchdog module 216, and a web server 218.

The Redis queue 212 may run in a backend which serves as a simple queuing mechanism. Redis is an open-source, networked, in-memory, key-value data store with optional durability. The Redis queue 212 may be used to pass data (e.g., IP addresses) between the grabber module 214 and the watchdog module 216. The grabber module 214 may put IP addresses in the Redis queue 212, which may be read by the watchdog module 216.

The grabber module 214 may be responsible for listening to an interface, reading packets, and/or assembling packets. The grabber module 214 may be written in any programming language, e.g., in C++ and may use a library dubbed as the libpcap library. The executable may take a name of an interface as a command line argument and may begin listening on that interface. The grabber module 214 may collect packets with the same acknowledgement (ACK) numbers. When the grabber module 214 sees a finish (FIN) packet, the grabber module 214 may extract the ACK number and assembles all packets having the same ACK number. In this step, the grabber module 214 may discard duplicate packets. Since there may not be a TCP connection between the cache 132 and the server 122, the cache 132 may know if some packets are missing when reconstructing packets, but the cache 132 may not request missing packets that were dropped on the way (e.g., between a forking switch and the cache 132). In other words, the cache 132 may eavesdrop on the client-proxy connection and figure out if some packets are missing, but may be unable to replace the missing packets. The grabber module 214 may then extract data from the extracted and assembled packets and may write back to a file in a disk with a default name. The grabber module 214 may also put a source IP, which is extracted from a packet, in the Redis queue 212.

The watchdog module 216 may communicate with the controller 142 using a set of REST calls. The watchdog module 216 may be written in Python and may use a library dubbed as the inotify library to listen on a cache directory for file write events. When the grabber module 214 writes a file to the disk, the watchdog module 216 may be invoked. The watchdog module 216 may call an API of the controller 142 to get a file name (using the IP stored in the Redis queue 212 as a parameter). The watchdog module 216 may subsequently strip HTTP headers from the file, change the file name, and write the file name back. After the file is saved, the watchdog module 216 may send back an acknowledgement message (denoted as ACK) to the controller 142 indicating that the file has been cached in the cache 132.

The web server 218 may be implemented as any cache server module (e.g., as an extended version of SimpleHTTPServer). The web server 218 may serve back a content to a client when the client requests the content. The web server 218 may be written in any suitable programming language (e.g., Python). Table 2 shows an embodiment of an implementation algorithm used by the cache 132.

TABLE 2
An examplary algorithm implemented by the cache 132

Send HELLO to controller;
Listen on cache interface;
Start webserver on cache directory;
if a HTTP response arrives then

| \| | Lookup the source IP of the response; | |
|---|---|---|
| \| | Query the controller with the source IP; | |
| \| | if the controller sends back a file name then | |
| \| | \| | Save the response with the file name; |
| \| | \| | Send back and ACK to the controller for the file name; |
| \| | else | |
| \| | \| | Discard the response; |

| | |
|---|---|
| \| | end |

else

| | |
|---|---|
| \| | Serve back the file using the webserver; |

end

The controller 142 may be implemented in any suitable form, e.g., as a Floodlight controller which is an enterprise-class, Apache-licensed, and Java-based OpenFlow controller. The controller 142 may comprise a cache manager module (denoted as CacheManager), which may be Java-based. Floodlight may be equipped with a standard Forwarding module, which may set up paths between arbitrary hosts. The controller 142 may subscribe to messages denoted as PACKET_IN events and may maintain two data structures for lookup. A first data structure 222 denoted as cacheDictionary may be used to map <client, server> pairs to request file names. The first data structure 222 may be queried using REST API to retrieve a file name corresponding to a request which has <client, server> information. A second data structure 224 denoted as requestDictionary may hold mapping of content and its location as the IP and port number of a cache. Table 3 shows an embodiment of a controller algorithm.

TABLE 3
An examplary algorithm implemented by the controller 142

Start controller on given port;
Initialize requestDictionary to null;
Initialize cacheDictionary to null;
if a HELLO arrives then

| | |
|---|---|
| \| | Register the device; |

end
if The proxy sends a set of port numbers then

| | |
|---|---|
| \| | Add those to the list P |

end
if A PACKET_IN arrives then

| | |
|---|---|
| \| | Select a port number from P, call it X; |
| \| | Parse the PACKET_IN to determine source and destination |
| | details; |
| \| | Populate a data structure of the form |
| \| | (X , clientip, clientport, serverip, serverport); |
| \| | Write forward and reverse flow on the switch from which the |
| \| | packet came; |

end
if The proxy queries with a file uri then

| \| | if The cacheDictionary does not contain the uri then | |
|---|---|---|
| \| | \| | Populate the requestDictionary with the URI, file name and |
| \| | \| | server IP and port; |
| \| | \| | Return ”None”; |
| \| | \| | Compute the forking switch between (server and proxy) and |
| \| | \| | (server and cache); |
| \| | \| | Write a fork flow to the computed switch; |
| \| | \| | Populate the cacheDictionary with the full uri, file name, |
| \| | \| | server IP, server port, cache IP, cache port, flag = 0; |
| \| | end | |
| \| | else | |
| \| | \| | Return cache IP and port if the flag for the entry is 1, |
| \| | \| | otherwise return ”None”; |

| | |
|---|---|
| \| | end |

end
if Cache queries with a server IP and server port then

| | |
|---|---|
| \| | Lookup the requestDictionary and return the file name; |

end
if Cache sends ACK for a uri then

| | |
|---|---|
| \| | Lookup the cacheDictionary and change flag to 1; |

end
else

| | |
|---|---|
| \| | Do nothing |

end

As mentioned previously, the disclosed mechanism may observe and extract content metadata at the network layer, and use the content metadata to optimize network behavior. The emerging SDN philosophy of separating a control plane and a forwarding plane demonstrates an examplary embodiment of the ICN architecture. Specifically, this disclosure teaches how an existing SDN control plane may be augmented to include a content management layer which supports TE and firewalling. The disclosed mechanism may not need any application layer involvement.

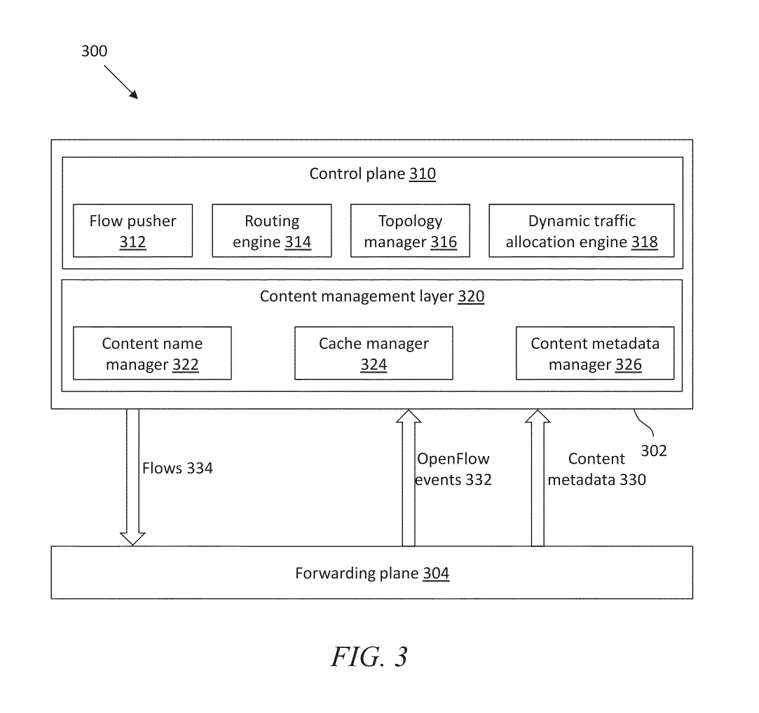

FIG. 3 is a diagram of an embodiment of an SDN implementation 300, highlighting interactions between an augmented control plane 302 and a forwarding plane 304. The control plane 302 may be an enhanced control plane incorporating a legacy control plane 310 and a content management layer 320 which has a number of modules for each task as shown in FIG. 3. The forwarding plane (sometimes referred to as data plane) 304 may also be an enhanced plane configured to send back content metadata 330 to a controller implementing the control plane 302, and the controller may make forwarding decisions. The control plane 302 may push back flows to the forwarding plane 304. Thus, the implementation 300 forms a closed feedback loop.

In use, OpenFlow controllers may deploy a modular system and a mechanism for modules to listen on OpenFlow events 332 such as PACKET_IN messages. Thus, the content management layer 320 may be implemented as a module or unit on a controller. The content management layer 320 may subscribe to PACKET_IN messages. When the content management layer 320 gets a packet, the content management layer 320 may extract metadata and then discard the packet. This architecture allows the controller side to have, when necessary, multiple content management layers chained together. In addition, the control plane 310 may send flows 334 to a switch implementing the forwarding plane 304, and the flows 334 set up rules for determining flow entries in one or more flow tables cached in the switch.

The legacy control plane 310 may comprise a flow pusher 312, a topology manager 314, a routing engine 316, and a dynamic traffic allocation engine 318. The content management layer 320 may comprise a content name manager 322, a cache manager 324, and a content metadata manager 326. The content metadata manager 326 may comprise a key-value store, which maps a content name (e.g., a globally unique content name) to some network-extracted metadata. As an example, content size or length is discussed herein as an examplary form of content metadata that is kept in the key-value store.

Modules in the content management layer 320 may fulfill various functionalities such as content identification, content naming, mapping content semantics to TCP/IP semantics, and managing content cashing policies. For example, content identification may use HTTP semantics, which indicates that, if a client in a network sends out an HTTP GET request to another device and receives an HTTP response, it may be conclude that the initial request was a content request which was satisfied by the content carried over HTTP (however, note that the response may be an error, in which case the request and its response may be ignored). Further, content identification may also be handled in a proxy, which may be directly responsible for connection management close to the client. The content management layer 320 may gather content information from the proxy which parses HTTP header to identify content.

There may be a number of caches and proxy nodes which can talk to an OpenFlow controller and announce their capabilities. Thus, the controller may decide to cache a content in a selected location (based on some optimization criteria). The proxy nodes may be configured to transparently demultiplex TCP connections between caches. In addition, some extra functionalities are described below.

To perform network resource allocation such as TE and firewalling by using content metadata (e.g., content length), content metadata first needs to be extracted. Two levels of extraction are discussed in this disclosure, with a first level at the network layer taking advantage of ICN semantics, and a second level going into the application layer.

In an embodiment, a network layer mechanism may be used to extract content length. Since a content may be uniquely identifiable in an ICN by its name, a controller (e.g., the controller 142) may recognize requests for a new content (that is, a content for which the controller holds no metadata in the key-value store). For the new content, the controller may set up a counter at a switch (e.g., an ingress switch) to count a size or length of a content flow. The controller may also instruct the flow to be stored in a cache, and may obtain the full object size from a memory footprint in the cache. Consequently, when the same content travels through the network later, a look-up to the key-value store may allow the controller to allocate resource based on the content size. Further, a content flow observed for the first time may be dynamically classified as an elephant flow or a mice flow based on a certain threshold, which may be determined by the controller. After classification, the content flow may be allocated with resources accordingly to optimize some constraints.

In an embodiment, an application layer mechanism may be used to extract content length. Specifically, an ingress switch may be configured to read HTTP headers contained in an incoming flow from a client. By parsing the HTTP headers, the switch may extract content size even when a content flow is observed for the first time. Parsing of HTTP headers may allow a controller to detect an elephant or mice flow and take appropriate actions relatively early. An advantage of this embodiment is that it may allow TE and firewalling from the first occurrence of a content flow.

For network elements or devices that have the ability to extract content metadata, they may announce this ability to the controller. Ability announcement may be done in-band using an OpenFlow protocol, since the OpenFlow protocol supports device registration and announcing features. In an embodiment, ability announcement may essentially involve several steps. In a first step of asynchronous presence announcement, a device may announce its presence by sending a hello message (sometimes denoted as HELLO) to an assigned controller. In a second step of synchronous feature query, the assigned controller may acknowledge the device's announcement and ask the device to advertise its features. In a third step of synchronous feature reply, the device may reply to the controller with a list of features. By performing these three steps for each applicable device, the controller can establish sessions to all devices and know their capabilities. The controller may then program network devices as necessary.

Given the setup described, the controller may obtain content metadata in a network. Also, the SDN paradigm may allow the controller to have a global view of the network. Thus, the platform can support implementation of various services, including four examplary services discussed in following paragraphs. These four examplary services are metadata driven traffic engineering, differentiated content handling, metadata driven content firewall, and metadata driven cache management.

A TE service may be driven by content metadata. Amongst various content metadata, since a controller may obtain the content length, the controller can solve an optimization problem under a set of constraints to derive paths on which the content should be forwarded. Large, modern networks often have path diversity between two given devices. This property can be exploited to do TE. For example, if an elephant flow is running on a first path between the two devices, the controller may instruct another elephant flow to run on a second path between the two devices. This TE approach may be relatively efficient and scalable, since it does not require a service provider to transfer content metadata separately, which saves network bandwidth at both ends.

Other types of metadata may also be used in TE. Deep packet inspection (DPI) mechanisms may enable a controller to obtain rich content metadata. Thus, with the presence of such a content metadata extraction service, the content management layer 320 may take forwarding decisions based on other metadata such as an MIME type of the content. The MIME type may define content type (sometimes referred to as an Internet media type). Based on the MIME type, a content may be classified into various types such as application, audio, image, message, model, multipart, text, video, and so forth. A network administrator can describe a set of policies based on MIME types. Take delay bound for example. If an MIME type is that of a real-time streaming content such as a video clip, the controller may select a path that meets delivery constraints (the delay bound which has been set). If none of the paths satisfies the delay bound requirement, a path offering the lowest excess delay may be selected as the optimal path. This approach may be used to handle multiple streaming contents on a switch by selecting different paths for each streaming content.

A firewall service may be driven by content metadata. For example, when a piece of content starts to enter a network, a controller controlling the network may obtain a size of length of the content. Thus, the controller may be able to terminate content flows handling the same content after a given amount of data, which may be determined by the controller, has been exchanged. This mechanism acts like a firewall in the sense that it opens up the network to transmit no more than an allowed amount of data. The content-size based firewall mechanism may provide stronger security or robustness than some traditional firewalls. For example, with a traditional firewall, a network administrator may block a set of addresses (or some other parameters), but it is possible for an attacker to spoof IP addresses and bypass the address-based firewall. With the disclosed content size-based firewall, a network may not pass through content flows which carry spoofed IP addresses, since the network knows that an allowed amount of content has already been transmitted through the network.

Cache management may be driven by content metadata. As object sizes of various content may vary in a cache (e.g., the cache 132), a caching policy implemented by the cache needs to know not only the popularity of the content and its frequency of access, but also the content size, in order to determine the best “bang for the buck” in keeping the content. The controller may have access to content requests as well as content size, thus the controller may make more informed decisions.

As mentioned previously, there may be no need to modify the client network and the service provider network, and proxy nodes may provide a tunnel to connect each client and each server to an OpenFlow network. In practice, a content requested by a client may be cached in a local OpenFlow network, which may be referred to as a cache hit, or may be unavailable in a local OpenFlow network, which may be referred to as a cache miss. In the event of a cache miss, the controller may instruct its local network to cache the content when the server serves it back.

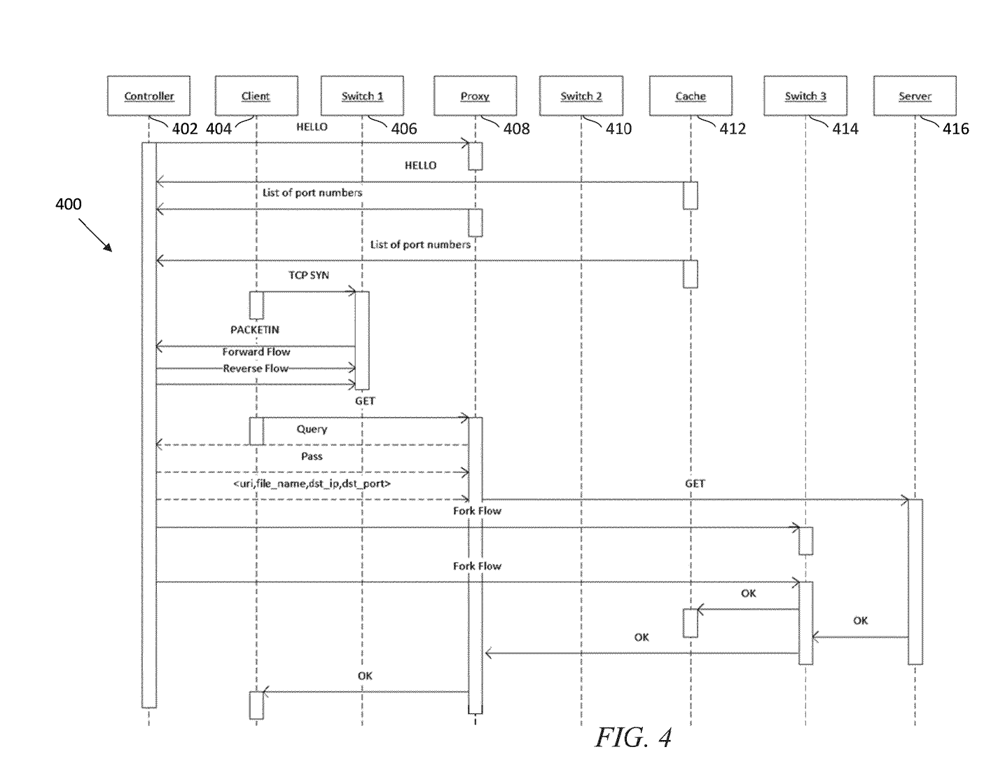

FIG. 4 is a diagram showing an embodiment of a message exchange protocol 400, which may be implemented by a network model disclosed herein (e.g., the network model 100) in the event of a cache miss. First, in a setup phase, one or more caches, proxy nodes, and switches may register with the controller. For example, as shown in FIG. 4, a controller 402 may initiate setup by sending a hello message (denoted as HELLO) to a proxy 408. The proxy 408 may respond by sending a list of port numbers back to the controller 402. Similarly, a cache 412 may send a hello message to the controller 402, and may further send a list of port numbers to the controller 402. Note that some of the messages, such as ACK messages from the controller to other devices, are omitted from FIG. 4.

After the setup phase, a client 404 may send out a TCP synchronize (SYN) packet, which may go to an OpenFlow switch 406 in the disclosed network through a tunnel (following a tunneling protocol). The switch 406 may not find a matching flow and may send the packet to the controller 402. Then, the controller 402 may extract from the packet various information fields such as a client IP address (denoted as client_ip), a client port number (denoted as client_port), a server IP address (denoted as server_ip), and a server port number (denoted as server_port). The controller 402 may then allocate a port number from a list of ports available on a proxy 408. The switch 406 may send a message denoted as PACKET_IN to the controller 402 indicating content metadata (e.g., content length) obtained by the switch 406. Then, the controller 402 may write a forward flow and a reverse flow to the switch 406, which sent the packet. Finally, the controller 402 may push the packet back to the switch 406, and the packet may go to the proxy 408.

Next, the client 404 may determine that a TCP session has been established between the client 404 and a server 416. Thus, the client 404 may send an HTTP retrieve (GET) request intended for the server 416 for a piece of content. The GET request may route through the proxy 408, which may parse the request and extract a content name and a destination server name (i.e., name of the server 416). Further, the proxy 408 may resolve the content name to an IP address. The proxy 408 may query the controller 402 with the content name. Accordingly, if a content identified by the content name is not cached anywhere in the network managed by the controller 402, the controller 402 may return a special value indicating that the content is not cached.

Since a cache miss occurs, the proxy 408 may connect to the server 416. Further, the proxy 408 may update the controller 402 with information of the content, including a server IP address, a server port, uniform resource identifier (URI) of the content, a file name of the content. For example, for the request, the proxy 408 may send a message in the form of <url, file name, dst_ip, dst_port> to the controller 402. Next, the controller 402 may populate its requestDictionary with information received from the proxy 408. The controller 402 may further select a cache 412 in which to place the content. The controller 402 may compute a forking point such that duplication of traffic may be minimized. The controller 402 may populate its cacheDictionary with the IP of the cache 412 to keep a record of where the content has been cached.

The controller 402 may write the fork flow to a selected switch 414. Note that another switch 410 may be selected if desired. As the server 416 serves back the content, the cache 412 may receive one copy of the content. The cache 412 may save the content and may query the controller 402 for the file name. Once complete, the cache 412 may send an ACK to the controller 402 indicating that the content has been cached. A second copy of the content intended for the client 404 may go to the proxy 408. Further, in an egress switch, the second copy may hit a reverse flow which may rewrite its source IP and port to that of the server. Eventually, the second copy of the content may reach the client 404, completing the transaction.

In an embodiment, a forward flow, a reverse flow, and a fork flow may have the following configuration:

1. Forward flow:

if src_ip=client ip and src_port=client_port and dest_ip=server_ip and dest_port=server_port,

then dest_ip=proxy_ip and dest_port=X

2. Reverse flow:

if src_ip=proxy_ip and dest_ip=client_ip,

then src_ip=server_ip and src_port=server_port

3. Fork flow:

if src ip=server ip,

then fork and output to two ports.

It can be seen that after a cache miss as shown in FIG. 4, when the same client or another client requests for the same content next time, the controller may know where the content is saved (i.e., cache hit) and the controller may redirect the request to that cache. Although cache hit is not illustrated using another figure, the process can be similarly understood. Specifically, in the event of a cache hit, the client 404 (component numbers in FIG. 4 used for convenience) may send a TCP SYN packet intended for the server 416, and the packet may go to the OpenFlow switch 406 in the disclosed network through a tunnel. Next, the switch 406 may not find a matching flow and may send the packet to the controller 402. The controller 402 may extract client_ip, client_port, server_ip, and server_port from the packet. The controller 402 may allocate a port number from the list of ports that the controller 402 has on the proxy 408. The controller 402 may write the forward and reverse flow to the switch 406 which sent the packet. Finally, the controller 402 may push the packet back to the switch 406.

The packet may go to the proxy 408, and the client 404 may think it has established a TCP session with the server 416. The client 404 may then send an HTTP GET request. The proxy 408 may parse the request to extract a content name and destination server name. The proxy 408 may further resolve the name to an IP address. The proxy 408 may query the controller 402 with the content name. The controller 402 may retrieve the cache IP from its cacheDictionary and may send an IP of the cache 412 back to the proxy 408. The proxy 408 may point to the cache 412, which may then serve back the content. In the egress switch, the reverse flow may be hit and a source IP and a source port may be rewritten.

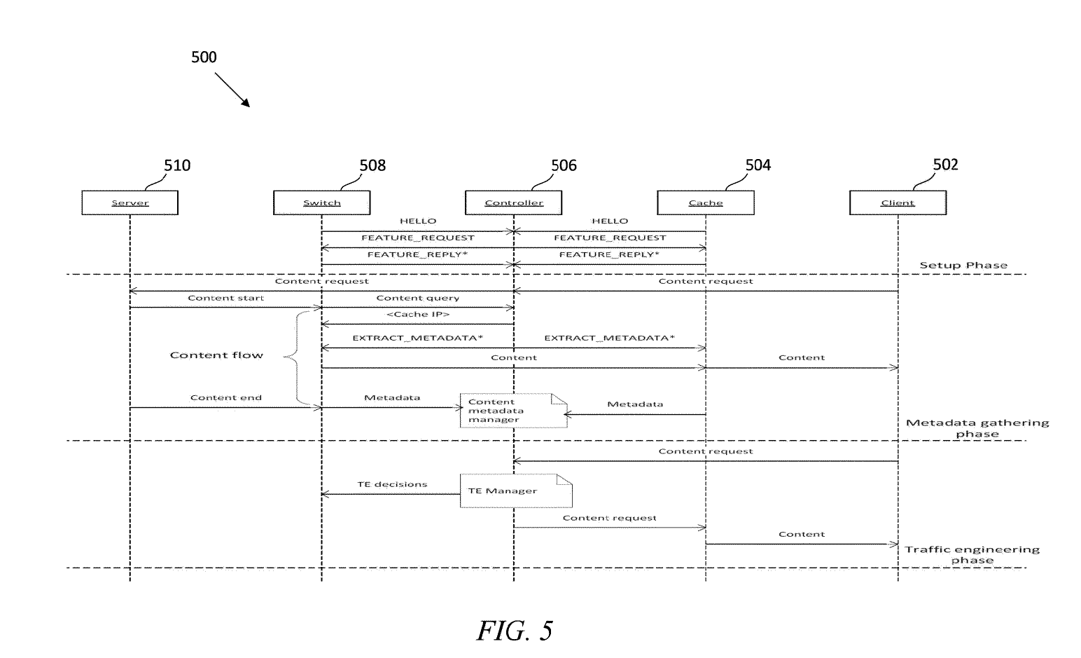

FIG. 5 is a diagram of another embodiment of a message exchange protocol 500, which shows end-to-end flow of a content in a network. In the example shown in FIG. 5, assume that the objective of TE is to optimize link bandwidth utilization by load balancing incoming content across redundant paths. Although, it should be understood that the choice of an optimization criteria may vary widely depending on implementation. For example, a caching network operator may wish to optimize disk writes while another operator might want to optimize link bandwidth usage. The optimization objective may be externally configurable since the architecture is independent of the underlying optimization problem. In implementation, sometimes it may be sufficient to have one optimization goal.

The message exchange protocol 500 may be divided into three phases: a setup phase where relevant devices, including a cache 504 and a switch 508, may connect or couple to a controller 506 and announce their capabilities; a metadata gathering phase where network devices may report back content metadata to the controller 506, and a third phase for TE.

The initial steps in the setup phase may be similar to the steps described with respect to FIG. 4. First, in the setup phase, various network elements including a cache 504 and a switch 508 may boot up and connect to a controller 506. The network elements may announce their capabilities to the controller 506. Specifically, the cache 504 may send a hello message to the controller 506, which may respond with a feature request message to the cache 504. The cache 504 may then respond with a feature replay message indicating a list of features or capabilities. Similarly, the switch 508 may send a hello message to the controller 506, which may respond with a feature request message to the switch 508. The switch 508 may then respond with a feature replay message indicating a list of features or capabilities. At this point, the controller 506 may have a map of the whole network it manages, thus the controller 506 may have knowledge regarding which network elements or nodes can extract metadata and cache content.

The controller 506 may write a special flow in all ingress switches, configuring them to extract content metadata. For example, the controller 506 may write a flow to the cache 504, asking the cache 504 to report back content metadata. A client 502, which may be located in a client network, may attempt to setup a TCP connection to a server 510, which may be located in a content or service provider network. The switch 508 (e.g., an OpenFlow switch) may forward packets from the client 502 to the controller 506. The controller 506 may write flows to redirect all packets from client 502 to a proxy (not shown in FIG. 5). At this stage, the client may be transparently connected to the proxy.

Next, in the metadata gather phase, the client 502 may send a GET request for a piece of content. The proxy may parse the request and query the controller 506 to see if that content is cached in the network managed by the controller 506. The first request for a piece of content may lead to a cache miss, since the content has not been cached yet. Thus the controller 506 may not return any cache IP, and the proxy may forward the request to the server 510 in the provider network.

The server 510 may send back the content which reaches an ingress switch 508. The switch 508 may ask the controller 506 (via a content query message) where the content should be cached. This marks the explicit start of the content. A special flow may be pushed from the controller 506 to each switch in the content path and where the content is cached. At this point, the controller may know where the content is cached.

Next time, if the same client or another client requests for the same content, the controller 506 may look up its cache dictionary by content name. The controller may identify the cache 504 where the content is stored, and the proxy may redirect the request to the cache 504. Simultaneously, the controller 506 may use a TE module to compute a path on which the content should be pushed to improve overall bandwidth utilization in the network. Table 4 shows an embodiment of a path selection algorithm that may be used by the controller 506. It should be understood that an optimization algorithm to be used in a specific situation may depend on an actual problem definition, and that the algorithm may be flexible. The controller 506 may write flows to all applicable switches to forward the content.

TABLE 4
An examplary path selection algorithm implemented by the controller 506

```
tempDictionary = null
P = get all routes from ingress switch to selected cache
for p in P do
  tempCost = 0
  for e in p do
    $tempCost = tempCost + \frac{{b}_{e} + F}{{c}_{e}}$
  end for
  insert (p, tempCost) in tempDictionary
end for
return the path corresponding to the minimum cost in tempDictionary
```

This disclosure teaches certain modifications to the existing OpenFlow protocol in order to support disclosed mechanisms. Content sent over HTTP is used as an example, since this type of content forms the majority of Internet traffic. One of ordinary skill in the art will recognize that other types of content can be similarly addressed by applying the mechanisms taught herein. From a top level, network elements may need to announce their capability of parsing and caching content metadata to the controller managing the network, which may be capable of writing flows.

During a handshake phase between a switch and its corresponding controller, the switch may need to announce its capability to parse content metadata. The controller may maintain a key-value data store or table comprising all or some switches that have advertised the metadata parsing capability.

In an embodiment, a handshake between a switch and its corresponding controller may works as follows. Either the controller or the switch may initiate the handshake by sending a hello message, and the other side may reply and set up a Transport Layer Security (TLS) session. Then, the controller may send a message denoted as OFPT_FEATURES_REQUEST (OFPT represents Open Flow Packet Type) to ask the switch of its features. The switch may announce its features or capabilities with a reply message denoted as OFPT_FEATURES_REPLY message, e.g., using an instance of an ofp_capabilities structure. Extra fields may be added to the ofp_capabilities structure to indicate capabilities to extract content metadata, cache content, and/or proxy content.

Once the controller connects to all network elements within its domain, the controller may know which elements can extract metadata. A control plane implemented by the controller may need to configure the network elements by writing flowmod messages, asking the network elements to parse content metadata. Thus, an additional action may be added on top of OpenFlow, which may be referred to as EXTRACT_METADATA. In an embodiment, a flowmod with this action is as follows:

if; actions=EXTRACT_METADATA,NORMAL,

which essentially means that the switch may extract metadata from HTTP metadata, place the metadata in a PACKET_IN message, and send back the PACKET_IN message to the controller. Later, the switch may perform a normal forwarding action on the packet.

This disclosure introduces a new type of flowmod to OpenFlow. This new type may provide ability to write flowmods which have an expiry condition, such as shown in the following:

if <conditions>; actions=<set of actions>

;until=<set of conditions>

Now, since a controller knows the length of a given content, the controller can use a per-flow byte counter to set a condition for the “until” clause shown above. For example, if a content length from a source IP address 192.168.122.21 to a destination IP address 63.212.171.121 is known to be x bytes, each flowmod in the network may have the form of:

if src_ip=192.168.122.21

and dst_ip=63.212.171.121;

actions=<output to some port>

;while=byte_counter<x

Note that the length of a content may be encoded in HTTP headers (note that it may be relatively easy to extend this mechanism to extract other content metadata such as MIME type). Once a switch is configured to parse a content flow, when the switch sees an HTTP packet contained in the content flow, the switch may read the content length from the HTTP header. Further, the switch may construct a tuple in the form of (contentname, contentsize, srcip, srcport, destip, destport). The tuple may be encapsulated in a PACKET_IN message, which may be sent back to the controller.

To demonstrate the benefit or advantage of the disclosed approaches, the following discussion deals with network TE or traffic optimization. One goal here may be to optimize some parameter of the network using content metadata that may be gathered through OpenFlow and may be available to a controller. The problem may be split into two sub problems. A first sub problem concerns storing the content in a cache, since a controller may need to select a path to the cache when the controller determines to store the content in the cache. Assuming a network has a number of alternate paths between the ingress switch and the selected cache, this may be an opportunity to use path diversity to maximize link utilization. Thus, here one objective may be to minimize the maximum link utilization, that is, to solve the following formula,

$$min max {\sum }_{ρ ∈ P}^{ } {\sum }_{e ∈ p}^{ } \frac{{b}_{e} + F}{{c}_{e}}$$

$$subject to {b}_{e} \leq {c}_{e}$$

The second sub problem concerns content retrieval. One goal here may be to minimize a time delay the client sees when requesting a content, that is, to solve the following formula:

$${min}_{e ∈ E} \frac{F}{{r}_{e}}$$

Table 5 summarizes notations used in the above two formulas:

TABLE 5
part of notations used herein

| | |
|---|---|
| bₑ | Background traffic on link e |
| cₑ | Capacity of link e |
| rₑ | Rate of link e |
| F | Size of the content |
| P | Set of all paths between a source and a destination |
| E | Set of all links |

Another interesting optimization problem that can be considered here is that of disk input/output (I/O) optimization. Given a number of caches in a network, each cache may have a known amount of load at a given time, thus it may be desirable to optimize disk writes over all caches and formulate the problem on this metric. Note that the actual optimization constraint to be used may vary depending on application requirements and may be user programmable. For example, optimization constraints may be programmed in the content management layer of the controller.

Content-based management may introduce new opportunities or approaches that have not been explored by the networking research community. Unlike an IP flow in a traditional network which may not have an explicit end-marker (note that the IP flow may time-out which is an implicit marker, but may require a proper time-out value), a content may have explicit beginning and end semantics. Thus, determining the amount of resource needed for the flow, as well as tracking how much data has passed through a network unit or device may be simplified. The ability to detect explicit markers or events may allow a network to perform firewall functions, e.g., allowing only a desired amount of content to pass through, and network resources may be automatically de-allocated once the content flow has ended.

The present disclosure may use caching as a primary ICN capability, which may result in decreased content access latency. Reduction in access latency for content delivery using the end-user agnostic approach increases overall network efficiency. This design pattern may ask that other network services such as traffic engineering, load balancing, etc., be done with content names and not with routable addresses. This disclosure is inspired by the observation that in an ICN, various information about a piece of content can be derived by observing in-network content flows or content state in a cache, or be derived by using deep packet inspection (DPI) mechanisms in switches.

In terms of evaluation, this disclosure may demonstrate that knowledge of content size prior to TE may be effectively used to decrease backlog in a link, which in turn results in less network delay. In an examplary setup, two parallel links are available between a source and a destination. Say, each of the two links has a capacity of 1 kilo-bits per second (kbps). Thus, a total capacity of the system is 2 kbps. At no point in time the input should be more than 2 kbps; otherwise a queue may go unstable. Further, assume that a content size is a Pareto distribution. Given a value of alpha (α) which is defined by the Pareto distribution, the value of a shape parameter may be calculated using relation:

$$b \leq 2 \frac{α - 1}{α} ,$$

so that the mean of the Pareto distribution is 1.95. Further, assume a deterministic arrival time of content to be once every second from t=1 second to t=10000 seconds.

Using these conditions, traffic may be allocated to each link based on one of the following policies. A first policy (Policy 1) assumes that a content size is not known prior to allocating links. Thus, at any point in time, if both links are at full capacity, a link may be picked or selected randomly. Alternatively, whichever link that is empty may be selected. Alternatively, a second policy (Policy 2) assumes that a content size is known prior to allocating links. In this case, at any time instant, a link with minimum backlog may be selected as the optimal link.

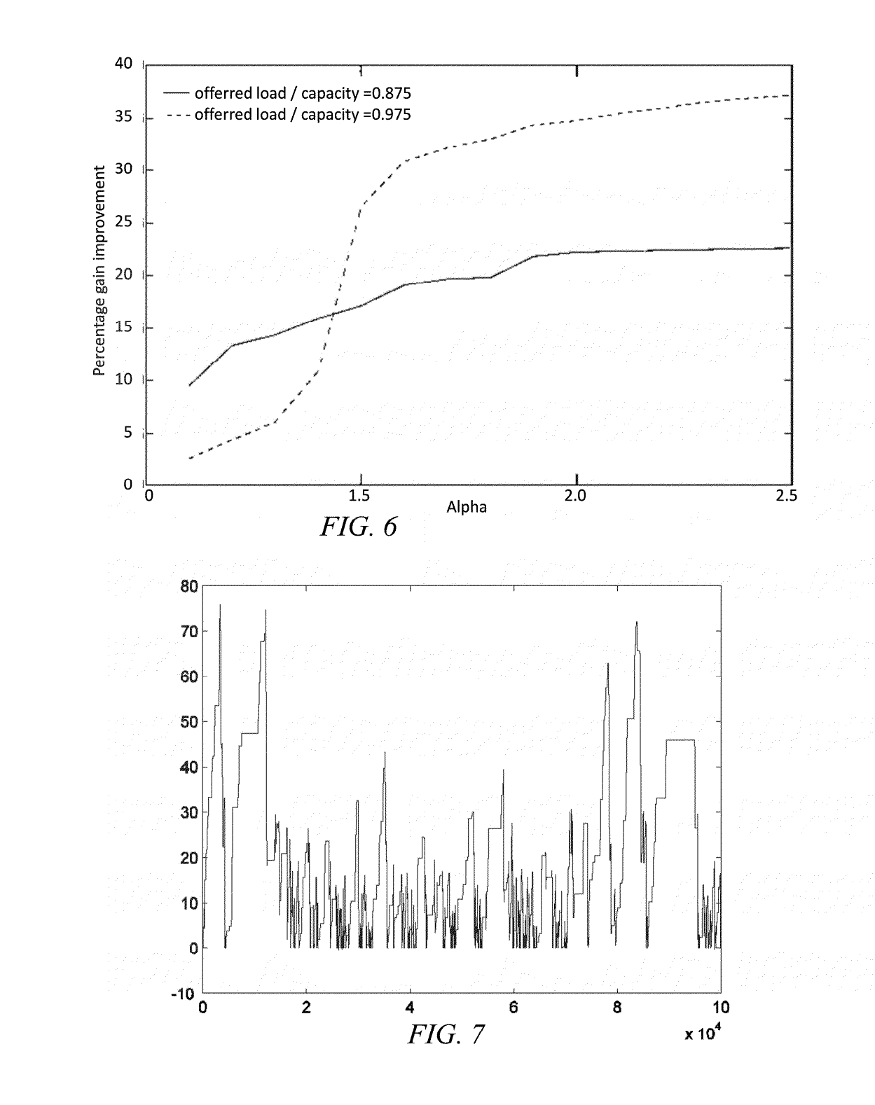

FIG. 6 is a diagram showing simulation results obtained using simulation program MATLAB. FIG. 6 studied the Policy 1 and the Policy 2 by plotting a difference in percentage (%) between a total backlog in the system under both policies, with increase in a from 1:1 to 2:5. For each value of a, the average backlog for a given policy was calculated by averaging out the backlogs in the two queues. FIG. 6 indicates that the size-aware Policy 2 better reduces the amount of data waiting to be transmitted, and thus reduces delay in the system. For instance, with a load/capacity ratio of 0:95, an average gain is up to 40% for Policy 2 and 26% for Policy 1.

For low traffic loads, there may be little or no need for traffic optimization. However, for high traffic load, links may become highly backlogged, and both Policies 1 and 2 are throughput optimal. It may be desirable to operate in a region where the link utilization is 1 or close to 1. Using this metric, Policy 2 shows significant improvements compared to Policy 1.

FIG. 7 is another diagram showing simulation results obtained using similar policies. Assuming all other conditions are the same with the setup for FIG. 6, a first policy assumes that a content size is not known prior to allocating links. Thus, at any point in time, if both links are at full capacity, a link may be picked or selected randomly. Alternatively, whichever link with the least traffic may be selected. Alternatively, a second policy assumes that a content size is known prior to allocating links. In this case, at any time instant, a link with minimum backlog may be selected as the optimal link. Note that both policies are throughput-optimal, but the difference lies in the fact that the first policy just looks at a current link state, while the second policy uses content metadata to predict or estimate future link state. FIG. 7 illustrates a difference in backlog between the first policy and the second policy (i.e., first policy backlog minus second policy backlog). It can be seen that the second policy significantly reduces backlog.

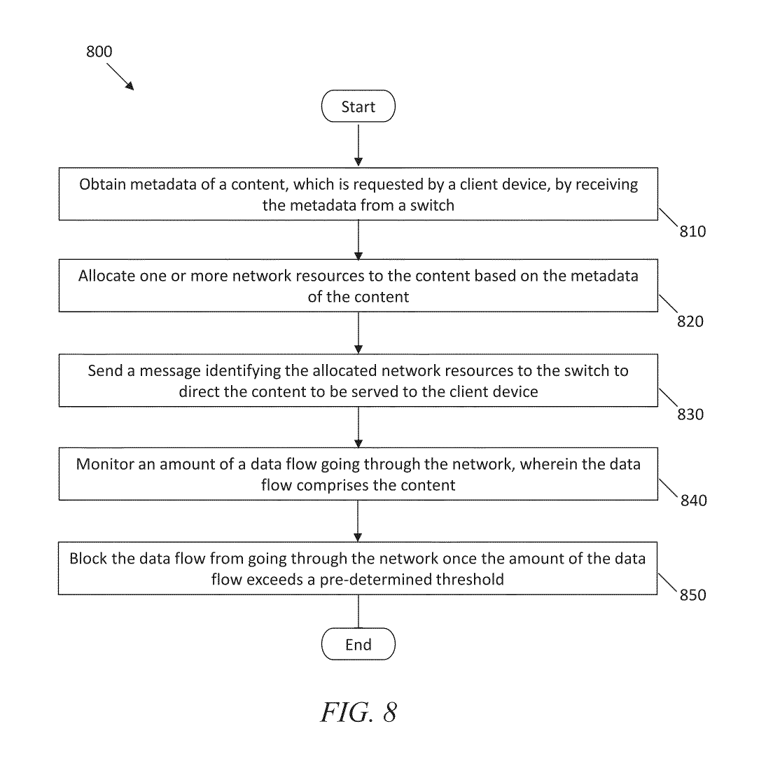

FIG. 8 is a flowchart of an embodiment of a method 800, which may be implemented by a network controller (e.g., the controller 142). The network controller may comply with an OpenFlow protocol, and a network managed by the controller may be an ICN implementing an SDN standard. The method 800 starts in step 810, in which the controller may obtain metadata of a content, which is requested by a client device, by receiving the metadata from a switch controlled by the controller. Note that the metadata may be obtained via any other fashion if desired. The client device may reside within or outside the network. In an embodiment, the content has a file name, a content size and an MIME type, and the metadata of the content includes at least one of the file name, the content size, and the MIME type.

In step 820, the controller may allocate one or more network resources to the content based on the metadata of the content. The controller may perform TE via allocation of network resources, since the controller has a global view and knowledge of the network. If the content size is obtained as metadata, the controller may have the option to classify a data flow carrying the content into either an elephant flow or a mice flow based on a pre-determined size threshold, and the elephant flow or the mice flow may at least partially determine the allocated network resources. In an embodiment, allocating the one or more network resources may comprise selecting a local path that at least partly covers a path between a cache in the network and the client device, wherein the cache is configured to store a copy of the content and serve the content to the client device using the selected local path. In this case, the local path may be selected from a number of paths available in the network following a set of constraints with a goal of optimizing a bandwidth of the local path, or optimizing disk write operations on the cache, or both. For example, the selected local path may have the least traffic backlog, if any, among the number of paths at a time of selection.

In step 830, the controller may send a message identifying the allocated network resources to the switch to direct the content to be served to the client device. The switch may then forward the content to the client device using the allocated network resources. In step 840, the controller may monitor an amount of a data flow going through the network, wherein the data flow comprises the content. In step 850, the controller may terminate or block the data flow from going through the network once the amount of the data flow exceeds a pre-determined threshold (threshold value is application-dependent). Steps 840 and 850 allow the controller to function as a metadata driven firewall.

It should be understood that the method 800 as illustrated by FIG. 8 covers a portion of necessary steps in serving a content to a client device, thus other steps may also be performed by the controller as appropriate. For example, if the content is sent from a server outside the network and is passing through the network for the first time, the controller may determine that the content is unavailable in the network. Further, the controller may appoint or instruct a cache located in the network to store a copy of the content, and record information that identifies both the content and the cache. Otherwise, if a copy of the content has already been stored in a cache in the network, the controller may determine a location of the cache, and redirect the request to the cache.

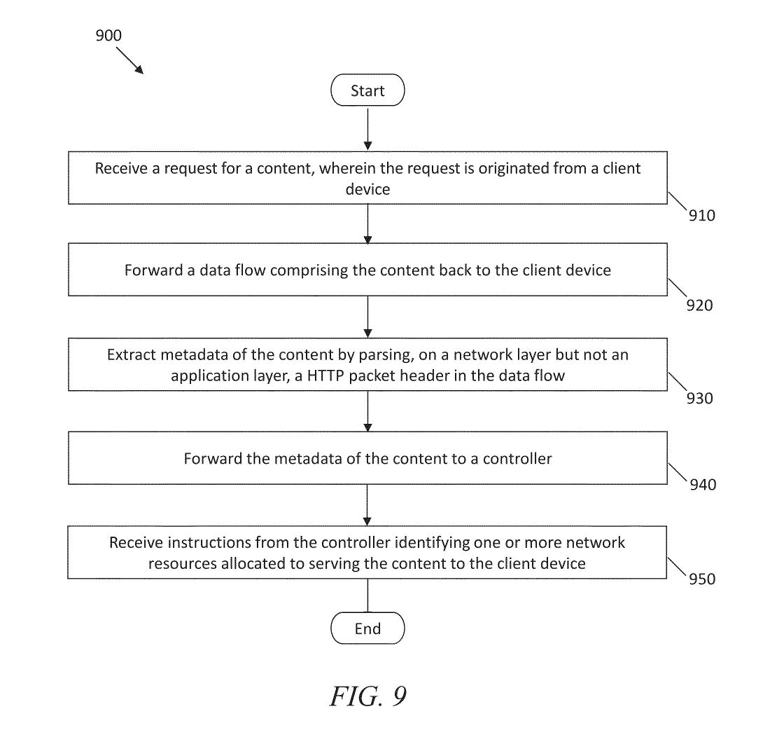

FIG. 9 is a flowchart of an embodiment of a method 900, which may be implemented by an SDN switch (e.g., the switch 140). The SDN switch may be located in a network or network domain (e.g., the network 130) managed by an SDN controller (e.g., the controller 142). The method 900 starts in step 910, in which the SDN switch may receive a request for a content, wherein the request is originated from a client device (e.g., the client 112). In step 920, the SDN switch may forward a data flow comprising the content back to the client device. Note that a source of the data flow may be a server outside the network or a cache within the network. In an embodiment, the data flow comprises an HTTP packet header, which in turn comprises a content name that uniquely identifies the content and a content size determined by the content name.

In step 930, the SDN switch may extract metadata of the content by parsing, on a network layer but not an application layer, the HTTP packet header. Extraction of the metadata may be performed during forwarding the data flow. In an embodiment, the content has a file name, a content size and an MIME type, and the metadata of the content includes at least one of the file name, the content size, and the MIME type. In step 940, the SDN switch may forward the metadata to the controller controlling the switch. In step 950, the SDN switch may receive instructions from the controller identifying one or more network resources allocated to serving the content to the client device. The one or more network resources may have been allocated by the controller based at least in part on the metadata. In an embodiment, the network resources identified by the instructions may comprise a local data path that at least partially covers a connection between a source of the content and the client device. Since the local data path is determined by the controller, the local data path may have the least traffic backlog, if any, among a number of local data paths available in the network for the content at a time when the instructions are received.

It should be understood that the method 900 as illustrated by FIG. 9 includes a portion of necessary steps in serving a content to a client device, thus other steps may also be performed by the SDN switch as appropriate. For example, if the content is sent from a server outside the network, the SDN switch may forward a copy of the content to a cache located in the same network. Otherwise, if the content has already been stored in the cache, the switch may forward a request for the content to the cache, so that a copy of the content can be retrieved from the cache. Further, in firewall applications, the switch may keep directing the data flow to the client device, until a data amount of the content passing through the switch or the network exceeds a pre-determined threshold.

Compared with prior attempts, the disclosed network may provide various advantages or benefits. Firstly, no modification is necessary at end points or hosts including both the client and the server. Secondly, the disclosed content management network may remain transparent to the end hosts, so the end hosts may be unaware of a cache or a proxy present in any flow paths. Thirdly, the disclosed network may be managed seamlessly with SDN (e.g., OpenFlow) and with ICN. Fourthly, the disclosed network may reduce latency of content access, and as a result, clients may notice that contents are being accessed faster. Fifthly, bandwidth usage or consumption in a network may be reduced by removing redundant flows (e.g., no need for a content to go from a server to a cache, if the content has already been stored in the cache).

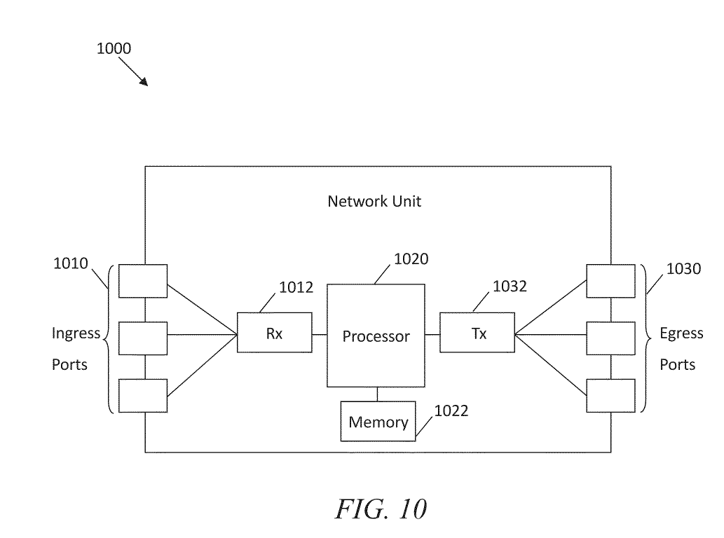

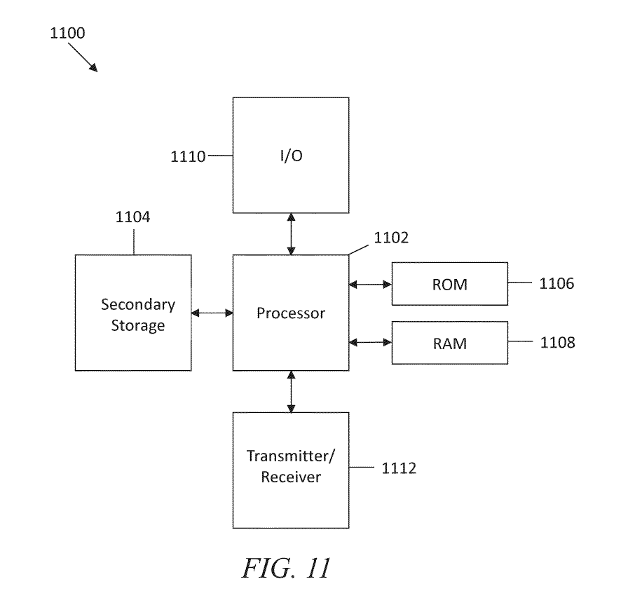

FIG. 10 is a diagram of an embodiment of a network device or unit 1000, which may be any device configured to transport packets through a network. For instance, the network unit 1000 may correspond to any of the caches 132-136, the proxy 138, or the switch 140. The network unit 1000 may comprise one or more ingress ports 1010 coupled to a receiver 1012 (Rx), which may be configured for receiving packets or frames, objects, options, and/or type length values (TLVs) from other network components.

The network unit 1000 may comprise a logic unit or processor 1020 that is in communication with the receiver 1012 and the transmitter 1032. Although illustrated as a single processor, the processor 1020 is not so limited and may comprise multiple processors. The processor 1020 may be implemented as one or more central processor unit (CPU) chips, cores (e.g., a multi-core processor), field-programmable gate arrays (FPGAs), application specific integrated circuits (ASICs), and/or digital signal processors (DSPs). The processor 1020 may be implemented using hardware or a combination of hardware and software. The processor 1020 may be configured to implement any of the functional modules or units described herein, such as the Redis queue 212, the grabber 214, the watchdog 216, the web server 218, the cache dictionary 222, the request dictionary 224, at least part of the forwarding plane 304, the control plane 310 including the flow pusher 312, the routing engine 314, the topology manager 316, and the dynamic traffic allocation engine 318, the content management layer 320 including the content name manager 322, the cache manager 324, and the content metadata manager 326, or any other functional component known by one of ordinary skill in the art, or any combinations thereof.

The network unit 1000 may further comprise a memory 1022, which may be a memory configured to store a flow table, or a cache memory configured to store a cached flow table. The memory may, for example, store the Redis queue 212, the cache dictionary 222, and/or the request dictionary 224. The network unit 1000 may also comprise one or more egress ports 1030 coupled to a transmitter 1032 (Tx), which may be configured for transmitting packets or frames, objects, options, and/or TLVs to other network components. Note that, in practice, there may be bidirectional traffic processed by the network unit 1000, thus some ports may both receive and transmit packets. In this sense, the ingress ports 1010 and the egress ports 1030 may be co-located or may be considered different functionalities of the same ports that are coupled to transceivers (Rx/Tx). The processor 1020, the memory 1022, the receiver 1012, and the transmitter 1032 may also be configured to implement or support any of the schemes and methods described above, such as the method 800 and the method 900.

It is understood that by programming and/or loading executable instructions onto the network unit 1000, at least one of the processor 1020 and the memory 1022 are changed, transforming the network unit 1000 in part into a particular machine or apparatus (e.g. an SDN switch having the functionality taught by the present disclosure). The executable instructions may be stored on the memory 1022 and loaded into the processor 1020 for execution. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner, as a machine controlled by a new ASIC is a particular machine or apparatus, likewise a computer that has been programmed and/or loaded with executable instructions may be viewed as a particular machine or apparatus.

The schemes described above may be implemented on a network component, such as a computer or network component with sufficient processing power, memory resources, and network throughput capability to handle the necessary workload placed upon it. FIG. 11 is a diagram of an embodiment of a computer system or network device 1100 suitable for implementing one or more embodiments of the systems and methods disclosed herein, such as the SDN controller 142.

The computer system 1100 includes a processor 1102 that is in communication with memory devices including secondary storage 1104, read only memory (ROM) 1106, random access memory (RAM) 1108, input/output (I/O) devices 1110, and transmitter/receiver 1112. Although illustrated as a single processor, the processor 1102 is not so limited and may comprise multiple processors. The processor 1102 may be implemented as one or more CPU chips, cores (e.g., a multi-core processor), FPGAs, ASICs, and/or DSPs. The processor 1102 may be configured to implement any of the schemes described herein, including the method 800 and the method 900. The processor 1102 may be implemented using hardware or a combination of hardware and software. The processor 1102 may be configured to implement any of the functional modules or units described herein, such as the Redis queue 212, the grabber 214, the watchdog 216, the web server 218, the cache dictionary 222, the request dictionary 224, at least part of the forwarding plane 304, the control plane 310 including the flow pusher 312, the routing engine 314, the topology manager 316, and the dynamic traffic allocation engine 318, the content management layer 320 including the content name manager 322, the cache manager 324, and the content metadata manager 326, or any other functional component known by one of ordinary skill in the art, or any combinations thereof.

The secondary storage 1104 is typically comprised of one or more disk drives or tape drives and is used for non-volatile storage of data and as an over-flow data storage device if the RAM 1108 is not large enough to hold all working data. The secondary storage 1104 may be used to store programs that are loaded into the RAM 1108 when such programs are selected for execution. The ROM 1106 is used to store instructions and perhaps data that are read during program execution. The ROM 1106 is a non-volatile memory device that typically has a small memory capacity relative to the larger memory capacity of the secondary storage 1104. The RAM 1108 is used to store volatile data and perhaps to store instructions. Access to both the ROM 1106 and the RAM 1108 is typically faster than to the secondary storage 1104.

The transmitter/receiver 1112 (sometimes referred to as a transceiver) may serve as an output and/or input device of the computer system 1100. For example, if the transmitter/receiver 1112 is acting as a transmitter, it may transmit data out of the computer system 1100. If the transmitter/receiver 1112 is acting as a receiver, it may receive data into the computer system 1100. Further, the transmitter/receiver 1112 may include one or more optical transmitters, one or more optical receivers, one or more electrical transmitters, and/or one or more electrical receivers. The transmitter/receiver 1112 may take the form of modems, modem banks, Ethernet cards, universal serial bus (USB) interface cards, serial interfaces, token ring cards, fiber distributed data interface (FDDI) cards, and/or other well-known network devices. The transmitter/receiver 1112 may enable the processor 1102 to communicate with an Internet or one or more intranets. The I/O devices 1110 may be optional or may be detachable from the rest of the computer system 1100. The I/O devices 1110 may include a video monitor, liquid crystal display (LCD), touch screen display, or other type of display. The I/O devices 1110 may also include one or more keyboards, mice, or track balls, or other well-known input devices.

Similar to the network unit 1000, it is understood that by programming and/or loading executable instructions onto the computer system 1100, at least one of the processor 1102, the secondary storage 1104, the RAM 1108, and the ROM 1106 are changed, transforming the computer system 1100 in part into a particular machine or apparatus (e.g. an SDN controller or switch having the functionality taught by the present disclosure). The executable instructions may be stored on the secondary storage 1104, the ROM 1106, and/or the RAM 1108 and loaded into the processor 1102 for execution.

Any processing of the present disclosure may be implemented by causing a processor (e.g., a general purpose CPU) to execute a computer program. In this case, a computer program product can be provided to a computer or a network device using any type of non-transitory computer readable media. The computer program product may be stored in a non-transitory computer readable medium in the computer or the network device. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), compact disc ROM (CD-ROM), compact disc recordable (CD-R), compact disc rewritable (CD-R/W), digital versatile disc (DVD), Blu-ray (registered trademark) disc (BD), and semiconductor memories (such as mask ROM, programmable ROM (PROM), erasable PROM), flash ROM, and RAM). The computer program product may also be provided to a computer or a network device using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R, and an upper limit, Rᵤ, is disclosed, any number falling within the range is specifically disclosed. In particular, the following numbers within the range are specifically disclosed: R=R+k*(Rᵤ−R), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means+/−10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method implemented by a network controller, the method comprising:
obtaining metadata of a content, wherein the content is requested by a client device;
allocating one or more network resources to the content based on the metadata of the content; and
sending a message identifying the allocated network resources to a switch to direct the content to be served to the client device, wherein the allocated network resources are used for forwarding the content from the switch, which is controlled by the network controller, to the client device.

2. The method of claim 1, wherein the metadata of the content is obtained by receiving the metadata of the content from the switch after the metadata of the content has been extracted from a data flow carrying the content.

3. The method of claim 2, wherein allocating the one or more network resources comprises selecting a local path that at least partly covers a path between a cache in the network and the client device for the cache to serve the content to the client device using the selected local path, and wherein the local path is selected from a number of paths available in the network following a set of constraints with a goal of optimizing a bandwidth of the local path, or optimizing disk write operations on the cache, or both.

4. The method of claim 3, wherein the selected local path has the least traffic backlog, if any, among the number of paths at a time of selection.

5. The method of claim 2, wherein the metadata of the content comprises a Multipurpose Internet Mail Extensions (MIME) type of the content.

6. The method of claim 2, wherein the metadata of the content comprises a size of the content.

7. The method of claim 6, further comprising:
after obtaining the size of the content and prior to allocating the one or more network resources, classifying a data flow carrying the content into either an elephant flow or a mice flow based on a pre-determined size threshold,
wherein the elephant flow or the mice flow at least partially determines the allocated network resources.

8. The method of claim 1, further comprising:
instructing the switch to monitor an amount of a data flow going through the switch, wherein the data flow comprises the content; and
instructing the switch to act as a firewall by blocking the data flow from going through the switch once the amount of the data flow exceeds a pre-determined threshold.

9. The method of claim 1, further comprising:
determining that a copy of the content is unavailable in a network controlled by the network controller;
instructing a cache located in the network to store the copy of the content; and
recording information that identifies the content and information that identifies the cache.

10. The method of claim 9, further comprising:
receiving a request for the content; and
determining, based on the recorded information, that the copy of the content is stored in the cache; and
redirecting the request to the cache from where the copy of the content is retrieved.

11. The method of claim 10, wherein a data flow carrying the content comprises a source address and a destination address as a pair, the method further comprising:
storing information that maps the source address and the destination address to a port number of a proxy; and
directing the data flow to a port on the proxy, wherein the port is identified by the port number.

12. The method of claim 9, wherein the network controller complies with an OpenFlow protocol, and wherein the network is an information centric network (ICN) implementing a software defined networking (SDN) standard.

13. An apparatus comprising:
a receiver configured to receive metadata of a content from a switch located in a same network with the apparatus, wherein the content is requested by a client device;
a processor coupled to the receiver and configured to:
allocate one or more network resources to the content based on the metadata of the content; and
direct the content to be served to the client device using the allocated network resources; and
a transmitter coupled to the processor and configured to transmit a message identifying the allocated network resources to the switch.

14. The apparatus of claim 13, wherein allocating the one or more network resources comprises selecting a local path that at least partly covers a path between a cache in the network and the client device for the cache to serve the content to the client device using the selected local path, and wherein the local path is selected from a number of paths available in the network since the selected local path has the least traffic backlog, if any, among the number of paths at a time of selection.

15. The apparatus of claim 13, wherein the content has a file name, a content size and a Multipurpose Internet Mail Extensions (MIME) type, and wherein the metadata of the content includes at least one of the file name, the content size, and the MIME type.

16. The apparatus of claim 13, wherein the processor is further configured to:
determine that a copy of the content is unavailable in the network;
instruct a cache located in the network to store the copy of the content; and
record information that identifies the content and information that identifies the cache.

17. A method implemented by a switch located in a network compliant to a software defined networking (SDN) standard, the method comprising:
receiving a request for a content, wherein the request is originated from a client device;
extracting metadata of the content;
forwarding the metadata to a controller configured to manage the network; and
receiving instructions from the controller identifying one or more network resources allocated to serving the content to the client device, wherein the one or more network resources are allocated by the controller based at least in part on the metadata.

18. The method of claim 17, further comprising:
obtaining source and destination address information by parsing the request;
locating a flow entry in a flow table based on the source and destination address information, wherein the flow table is stored in the switch;
reading the flow entry to determine a location of a cache that is located in the network and configured to store a copy of the content; and
forwarding the request to the cache.

19. The method of claim 17, further comprising forwarding a data flow comprising the content back to the client device, wherein the data flow comprises a Hypertext Transfer Protocol (HTTP) packet header, wherein the HTTP packet header comprises a content name that uniquely identifies the content and a content size determined by the content name, wherein extracting the metadata comprises parsing, on a network layer but not an application layer, the HTTP packet header to obtain the content size, and wherein the content size is forwarded to the controller.

20. The method of claim 17, wherein the one or more network resources identified by the instructions comprises a local data path in the network, wherein the local data path at least partially covers a connection between a source of the content and the client device, and wherein the local data path has the least traffic backlog, if any, among a number of local data paths available in the network for the content at a time of receiving the instructions, the method further comprising:
receiving a data flow comprising the content; and
directing the data flow to the client device following the local data path, until a data amount of the content passing through the switch exceeds a pre-determined threshold.

21. A switch located in a network, the switch comprising:
at least one receiver configured to receive a request for a content, wherein the request is originated from a client device;
a processor coupled to the at least one receiver and configured to extract metadata of the content; and
one or more transmitters coupled to the processor and configured to forward the metadata to a controller managing the network,
wherein the at least one receiver is further configured to receive instructions from the controller identifying one or more network resources allocated to serving the content to the client device, wherein the one or more network resources are allocated by the controller based at least in part on the metadata.

22. The switch of claim 21, further comprising a memory coupled to the processor and configured to store a flow table, wherein the processor is further configured to:
obtain source and destination address information by parsing the request;
locate a flow entry in the flow table based on the source and destination address information; and
read the flow entry to determine a location of a cache that resides in the network, which complies to a software defined networking (SDN) standard, and stores a copy of the content,
wherein the one or more transmitters are further configured to forward the request to the cache.

23. The switch of claim 21, wherein the one or more network resources identified by the instructions comprises a local data path in the network, wherein the local data path at least partially covers a connection between a source of the content and the client device, and wherein the local data path has the least traffic backlog, if any, among a number of local data paths available in the network for the content at a time of receiving the instructions, wherein the at least one receiver is further configured to receive a data flow comprising the content, and wherein the processor is further configured to direct the data flow to the client device following the local data path, until a data amount of the content passing through the switch exceeds a pre-determined threshold.
